(19) United States
(12) Patent Application Publication
(10) Pub. No.: US 2006/0070692 A1
(43) Pub. Date: Apr. 6, 2006

(54) Tyre for vehicle wheels with reinforced bead structure

(76) Inventors: Claudio Lacagnina, Busto Arsizio (IT); Rodolfo Noto, Gorgonzola (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/518,466

(22) PCT Filed: Jun. 27, 2002
(86) PCT No.: PCT/IB02/02457

§ 371 Date: Aug. 10, 2005

(51) Int. Cl. B60C 15/00; B60C 15/06; B60C 15/05; B60C 15/04; B60C 9/02

(52) U.S. Cl. 152/539; 152/540; 152/545; 152/548; 152/550; 152/543

(57) ABSTRACT

A tyre for a vehicle wheel includes a toroidal carcass, a tread band, and a belt structure. The carcass includes a central crown portion and two axially opposite sidewalls. The axially opposite sidewalls end in a pair of beads for mounting the tyre on a corresponding rim. Each bead includes at least one annular reinforcing core. The tread band is disposed at the central crown portion of the carcass, coaxially extends about the carcass, and includes a relief pattern for rolling contact with the ground. The belt structure is coaxially interposed between the carcass and the tread band. The carcass further includes at least one carcass ply. Ends of the at least one carcass ply are anchored to the annular reinforcing cores. The at least one carcass ply includes a portion that encloses at least one insert in proximity to the annular reinforcing cores.

The present invention relates to tyres for motor vehicle wheels having reformed beat structure.

A tyre traditionally comprises a carcass with toric shape, having a central crown area connected at its ends with a pair of axially opposite sidewalls, radially developed inwardly, each ending in a bead destined to anchor the tyre to a corresponding mounting rim. For this purpose, a metallic reinforcing ring is enclosed in the bead.

Around said carcass is coaxially positioned a tread band destined to the rolling contact of the tyre on the ground, provided with a relief pattern, defined by notches and grooves obtained in the thickness of said band, able to guarantee the necessary behavioural features of the tyre in operation.

The carcass reinforcement structure comprises at least a ply of rubberised fabric constituted by a sheet of rubber within which are buried reinforcing textile or metallic cords arranged transversely relative to the circumferential direction of the tyre: in radial carcass tyres, the direction of the aforesaid cords is orthogonal to said circumferential direction, i.e. to the equatorial plane of the tyre.

When the carcass is radial, it also comprises a belt structure positioned around the carcass, interposed between carcass and tread band, extended from one sidewall to the other of the tyre, i.e. substantially as wide as the tread band.

The aforesaid structure traditionally comprises one or more strips of rubberised fabric provided with reinforcing cords, mutually parallel in each strip and crossed with those of the adjacent strips, preferably inclined symmetrically relative to the equatorial plane of the tyre.

Preferably, said belt structure further comprises in radially external position, at least on the ends of the underlying strips, also an additional layer of textile or metallic strips, positioned circumferentially (at 0 degrees),

The mounting rims of the tyres have, in correspondence with their axial ends, two coaxial surfaces, generally of substantially conical shape, which constitute the bearing seat of the beads of the tyre, better known as bead seats. The axially external edge of said seats ends with a flange extended radially outwards, usually known as rim flange, which serves as a support for the axially external surface of the bead and against which the aforesaid bead is kept in abutment by the inflation pressure of the tyre.

The forcing of the tyre bead in its seat is assured by the conicity of the outwardly open bearing seat, in collaboration with the metallic reinforcing ring, contained in the tyre bead: such forcing, created by the axial thrust exerted on the sidewall of the beads, axially from the interior towards the exterior, by the inflation pressure of the tyre, assures the stability of the tyre bead on the rim during operation and, in tubeless tyres, also the air tightness between the tyre and rim in order to prevent a progressive deflation of the tyre.

According to modern manufacturing techniques, as disclosed for instance in the document EP 928 680 by the same Applicant, a tyre is formed directly on a toroidal support by means of superposition according to coils, set axially side by side and/or radially superposed, of an elementary semi-finished product of appropriate dimensions wound on said support in a phase immediately subsequent to its own realisation. In particular, three different types of elementary semi-finished products are used, to wit: a section bar made solely of elastomeric material, with substantially rectangular section, hereinafter referred to as “elongated element”; a strip of elastomeric material within which are enclosed elongated reinforcing elements, typically textile or metallic cords, hereinafter defined as “strip-like element”; and rubberised metallic wires or cords.

It should be specified herein that, for the purposes of the present description, the term “elastomeric material” means a composition comprising at least an elastomeric polymer and at least a reinforcing charge. Preferably, said composition further comprises additives such as cross-linking and/or plasticiser agents. Thanks to the present of the cross-linking agents, said material can be cross-linked by heating, thereby forming the final artefact.

In tyres, and in particular in those manufactured for medium/heavy road transport of the tubeless type, the bead area is a highly critical one which often undergoes a structural collapse well before the tread is completely worn, determining the out-of-service condition of the tyre.

The document WO 00/34059 by the same Applicant discloses a tyre for vehicle wheels, comprising a toroidal structure that has a central crown portion and two axially opposite sidewalls ending in a pair of beads for anchoring the tyre to a corresponding mounting rim, each bead comprising at least an annular reinforcing core, a tread band placed at the crown and coaxially extended about said carcass, provided with a relief pattern for the rolling contact with the road, and a belt structure coaxially interposed between said carcass and said tread band, said carcass being provided with a reinforcing structure substantially constituted by at least a ply of rubberised fabric, reinforced with metallic cords lying radial planes containing the axis of rotation of the tyre, said reinforcing structure having its own ends anchored to said annular reinforcing cores, and a neutral profile, lying in a plane with radial straight section, axially extended from bead to bead, in which said neutral profile intersects the straight section of the field that encloses said annular reinforcing cores, and the ends of said reinforcing structures extend radially inwards not beyond the radially innermost profile of said annular reinforcing cores, said neutral profile presenting a continuous curvature without inflexion points along its development between said beads.

The Applicant has verified that by means of the teachings disclosed in the aforesaid document, considerable improvements are obtained in terms of the behaviour of the tyre in operation. By forcing the neutral profile of the carcass plies to pass inside the bead ring, preferably through its centre of gravity, thereby eliminating the inflexion point, a substantially reduction of the torque discharged by the carcass plies on the bead in the tyre inflated to operating pressure. Said torque, during the operation of the tyre, varies with each cycle of rotation of the tyre, causing cyclical micro-movements in the entire structure of the bead (in particular, micro-rotation of the bead about is axially external edge), which in more or less rapid times cause a structural collapse.

The Applicant, however, has noted experimentally that, because of the complex mechanical interaction between carcass and bead rings, of the particular coupling of the different materials of the components constituting the bead (textile or metallic cords, elastomeric materials of different composition, rubberised cords, etc.), as well as of the small imperfections often present in each productive process, the bead is still cyclically subjected to a condition of stress during the operating life of the tyre.

More specifically, the intensity of the stresses and of their variation along the interface between the elastomeric material of the carcass and the bead rings can give rise, in some cases, to an uncontrolled propagation of cracks which may lead to the disengagement of the carcass ply or plies from the bead rings and to the consequent early out-of-service condition of the tyre.

The Applicant has then intuited that a reduction of the stresses in the bead areas and/or a reduction thereof in the critical parts such as the carcass/bead rings interface can, for equal loads, considerably extend the operating life of the tyre and its safety in operation. The Applicant has found that enclosing in the bead area at least an insert within at least a carcass ply one achieves a reduction of the stresses and of their gradient in the more critical area of the bead itself, i.e. in the carcass/bead ring(s) interface, and a considerable reduction of the risk of disengagement of the carcass ply/plies from the bead ring(s) thanks to a mechanical block exerted on said carcass ply/plies by differentiated portions of the bead ring(s).

According to a first aspect the invention relates to a tyre for vehicle wheels, comprising a toroidal carcass which has a central crown portion and two axially opposite sidewalls ending in a pair of beads for anchoring the tyre to a corresponding mounting rim, each bead containing at least a reinforcing annular core, a tread band placed at the crown and coaxially extended around said carcass, provided with a relief pattern for the rolling contact with the road, and a belt structure coaxially interposed between said carcass and said tread band, said carcass comprising at least a carcass ply, said at least one carcass ply having its own ends anchored to said annular reinforcing cores, wherein said at least one carcass ply comprises a portion that encloses within its own interior at least an insert in proximity with said annular reinforcing cores.

In a preferred embodiment of said tyre according to the invention, said insert comprises at least an elongated metallic element having a plurality of coils radially superposed on themselves.

In an embodiment variation of the aforesaid tyre, said elongated metallic element is associated to a filler made of elastomeric material.

In an additional preferred embodiment of the subject tyre, said insert comprises an elastomeric material.

In another embodiment variation of the aforesaid tyre, said elastomeric material has a hardness in Shore A degrees that ranges between 70 and 90.

In a different embodiment of the tyre according to the invention, said carcass ply comprises a plurality of strip-like elements that enclose said insert.

In an embodiment variation of said tyre, each strip-like element is laid onto a toroidal support, whose outer profile substantially coincides with the radially inner surface of said tyre, by means of a circumferential pitch that is twice the width of each strip-like element, in such a way as to enclose at least a part of said insert together with the adjacent strip-like element.

In another embodiment of the aforesaid tyre, said elongated metallic element comprises a plurality of wires, each of which has an ultimate tensile stress of between 500 and 5000 N.

In a different preferred embodiment of said tyre, said carcass has a neutral profile, laying in a plane of radial straight section, axially extended from bead to bead, wherein said neutral profile intersects the straight section of a field that encloses said annular reinforcing cores, said neutral profile along its development between said beads having a continuous curvature without inflexion points.

In an additional embodiment of said tyre, said insertion has a height of between 1 and 35 mm measured in the radial direction.

In a different embodiment of the subject tyre, said tyre comprises at least a reinforcing insert in a position radially external to said annular reinforcing cores.

In another preferred embodiment of said tyre, it comprises a reinforcing edge in a position that is axially external and radially internal to at least one of said beads.

Further features and advantages of the invention shall become more readily apparent from the detailed description of some preferred, but not exclusive, embodiments, of a tyre for vehicle wheels with reinforced bead structure according to the present invention.

Said description shall be exposed hereafter with reference to the accompanying drawings, provided solely by way of non limiting indication, in which:

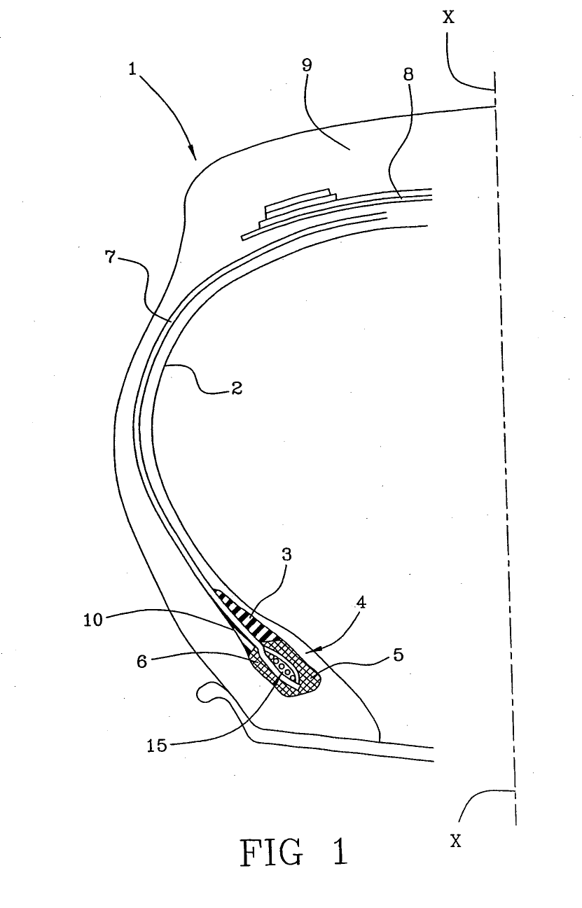

FIG. 1 is a partial schematic straight section view that shows a tyre for vehicle wheels according to the invention.

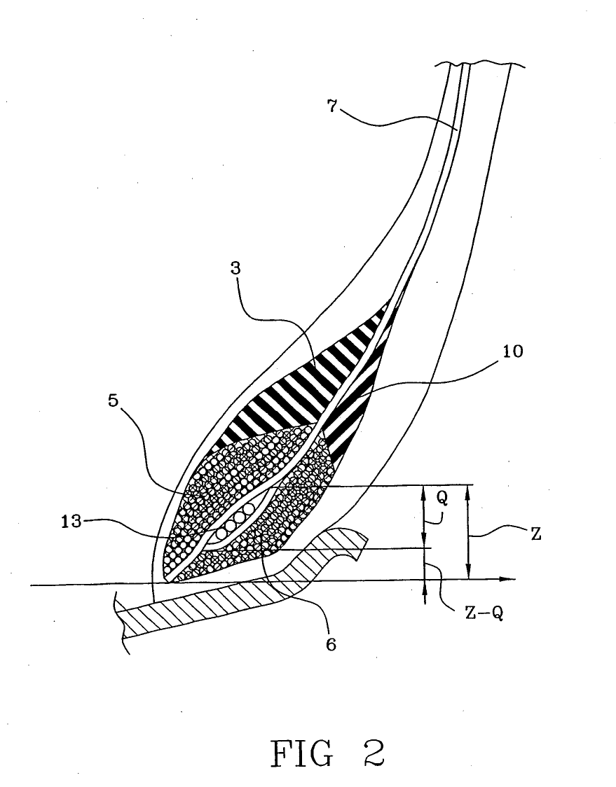

FIG. 2 is an enlarged, partially sectioned view of a bead belonging to the tyre shown in FIG. 1.

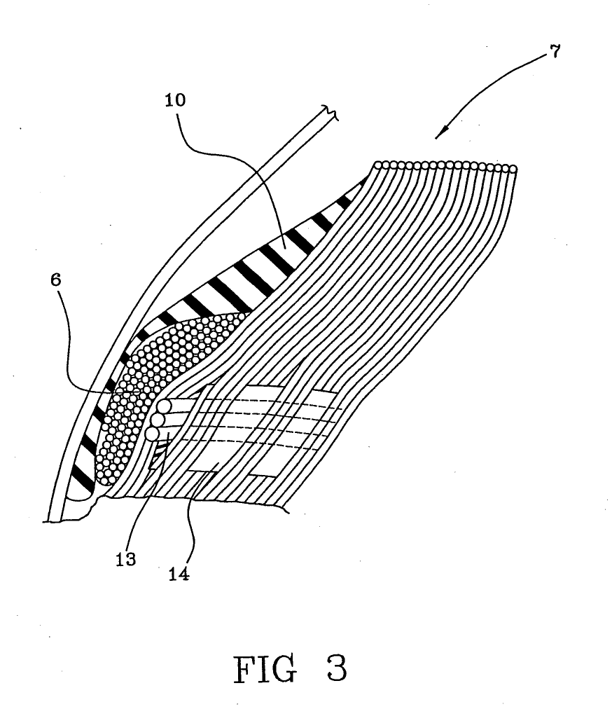

FIG. 3 is an enlarged, partially sectioned, perspective view of a detail of the bead shown in FIG. 2.

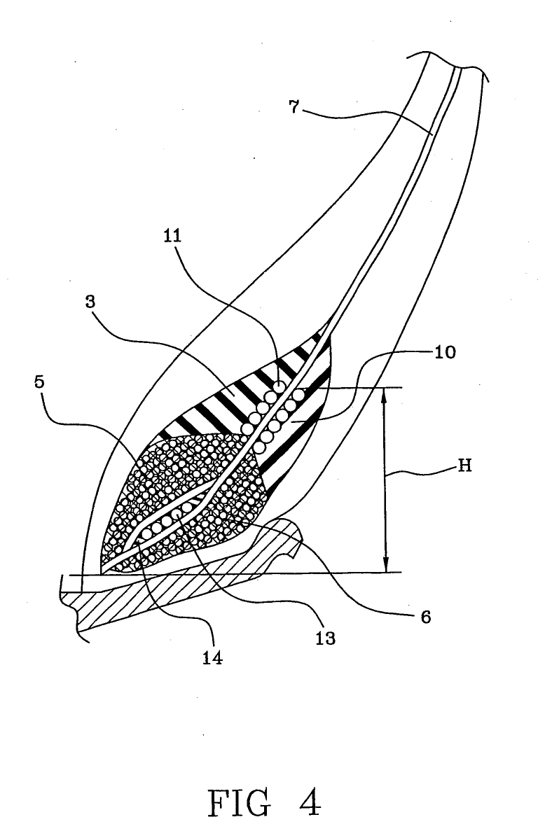

FIG. 4 is a partially sectioned view of a bead of a tyre according to a different embodiment of the invention.

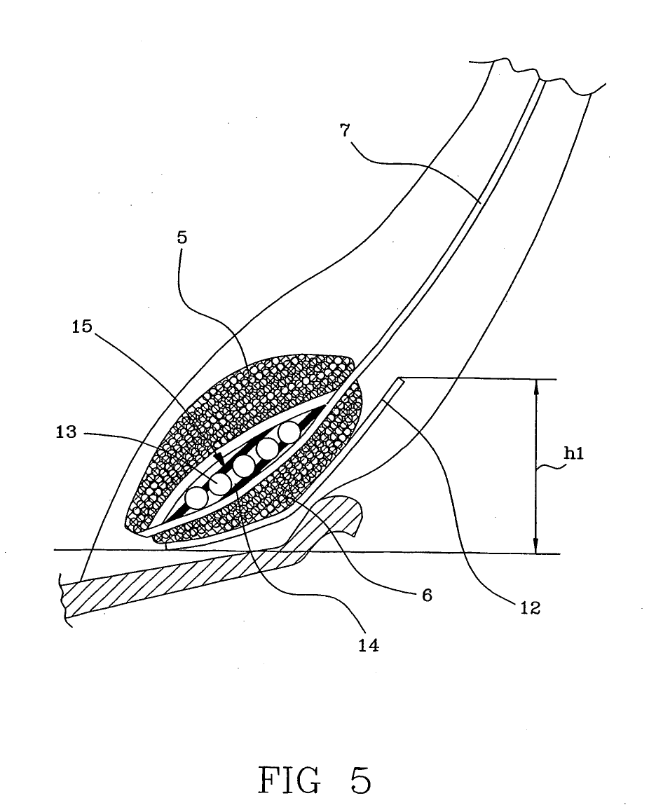

FIG. 5 is a partially sectioned view of a bead of a tyre according to an additional embodiment of the invention.

In the remainder of the present description, reference shall be made to the neutral profile of the carcass ply/plies: said profile coincides with the profile of the carcass ply when the ply is a single one, or when two or more plies are in mutual contact with each other, but deviates therefrom when they move away from each other. In this case the neutral profile corresponds to the profile of the neutral axis of the complex externally delimited by said plies.

FIG. 1 schematically shows a first preferred embodiment of the tyre 1 according to the invention, said tyre comprising a toric shaped carcass, having a central crown area connected at its ends with a pair of axially opposite sidewalls, radially developed inwardly, each ending in a bead destined to anchor the tyre to a corresponding mounting rim. Said tyre 1 also comprises a sheet 2 of elastomeric material called “liner” in a position that is radially internal to said carcass, at least a reinforcing annular core 5, 6, inside said beads, fillers of elastomeric material 3, 10, in radially external position relative to said reinforcing annular cores 5, 6, a belt structure 8, coaxially placed crown-wise to the carcass and interposed between the aforesaid carcass and a tread band 9, said carcass comprising at least a carcass ply 7 that encloses in one of its portion, as shall become more readily apparent hereafter, an insert 15.

Said tyre 1 is preferably obtained with the technology described in the aforementioned document EP 0 928 680 by the same Applicant.

Briefly, said tyre 1 is directly formed on a toroidal support (not shown herein) by means of superposition according to coils, set axially side by side and/or radially superposed, of an elementary semi-finished product of appropriate dimensions wound on said support in a phase immediately subsequent to its realisation.

More specifically, on a toroidal support whose outer profile substantially coincides with that of the radially inner surface of the green tyre are laid the inner elements of the tyre 1, starting from the so-called liner 2, which in the vulcanised tyre constitutes the inner surface of the tyre, impermeable to air.

Before the realisation of at least said one carcass ply 7, one or more elastomeric fillers 3 are laid on said toroidal support, said fillers having in the straight section of the tyre 1 a shape that is radially tapered outwards, as shown in FIG. 1.

A first annular reinforcing core is also formed in a position that is radially internal to said elastomeric filler 3.

Preferably, said annular reinforcing core comprises a bead ring 5, constituted by a set of metal wire coils radially superposed and set axially side by side to each other.

Said set of coils can be obtained by winding on said support or on a different manufacturing drum, a plurality of coils radially superposed on themselves and set axially side by side to each other, made of metal wire or, alternatively, of a cord of metal wires, or of a ribbon of said wires or cords or else of a flat metal strip.

The material constituting the bead ring can be made of any textile or metallic material, of a material of yet another nature, provided with suitable mechanical strength characteristics; preferably, said material is steel, normal or with high carbon content (high tensile steel), commonly used in tyre technology, and preferably used in the form of metal cord.

The ultimate tensile stress of each wire constituting said cord can vary between 500 and 5000 N/wire. Preferably, the Applicant advantageously employ cords made of steel with high carbon content in the 7×3×0.30 formation (i.e. cords constituted by 7 strands of three wires each, each wire having a diameter of 0.3 mm).

The next stage is the construction of the carcass reinforcing structure, i.e. of at least a carcass ply 7, laying on said toroidal support, in circumferential succession, a plurality of strip-like elements, i.e. of strips of rubberised fabric each containing a certain number of cords, with the cords arranged radially, i.e. at 90° relative to the circumferential direction of the support. The strip-like elements are made to adhere to the underlying layers over their whole longitudinal development, extended from bead to bead along the outer surface of the support itself.

Advantageously, said carcass ply 7 is formed on said toroidal support by laying, as shall become more readily apparent hereafter, at least a first and a second series of the aforesaid strip-like elements.

Each strip-like element is preferably obtained by cutting in sequence, into a plurality of segments of predetermined length, a continuous elongated element (not illustrated herein), obtained previously, each segment forming one of the aforesaid strip-like elements, as described for instance in the document EP 0 976 535 by the same Applicant.

Once manufactured, each strip-like element is laid onto said toroidal support, shaping the strip-like element according to a “U” configuration about the cross section profile of the toroidal support itself, in such a way that in the strip-like element it is possible to identify two lateral portions developing radially towards the axis of the toroidal support, in positions that are axially distanced from each other, and a portion of crown extending in radially external position between the lateral portions.

Said toroidal support can be actuated in angular rotation according to a stepped actuation in synchrony with the laying of the aforesaid strip-like element, in such a way that each strip-like element is laid onto the toroidal support itself in a circumferentially distanced position relative to the previously laid strip-like element. More in particular, the rotation of the toroidal support takes place according to an angular pitch whereto corresponds a circumferential displacement equal to a multiple, and advantageously to double, the width of each strip-like element.

It should be noted that, for purposes of the present description, unless otherwise indicated, the term “circumferential” refers to a circumference lying in the equatorial X-X plane and in proximity to the outer surface of the toroidal support.

According to the present invention, the operative sequence described above is such that, with a first complete revolution of the toroidal support about its own axis, the first series of strip-like elements are laid, circumferentially distributed according to a circumferential pitch equal to double the width of each strip-like element.

Subsequently, the laying of said insert 15 starts. The insert can comprise in conjunction or alternatively an appropriate elastomeric material or at least an elongated metallic element.

According to a first preferred embodiment, on said first series of strip-like elements is laid an elongated metallic element 13 wholly equivalent to the one employed for the aforesaid first bead ring 5, preferably winding onto said toroidal support a plurality of coils radially superposed on themselves and optionally set axially side by side to each other (see, for instance, FIG. 1). Before and after the laying of said metallic element, a filler 14 substantially comprising an appropriate elastomeric material is laid in a radially internal and external, and axially internal and external position thereto.

Alternatively, according to a different embodiment, an insert 15 comprising an elastomeric material of appropriate hardness, preferably ranging between 70 and 90 Shore A degrees, can be laid.

A new series of strip-like elements is then laid in the intervals left between the strip-like elements laid previously: the ends of said strip-like elements are superposed in a position that is axially external to the bead ring 5 already assembled to the support and, according to said first embodiment, to the aforesaid previously laid elongated metallic element 13, so that the latter is interposed between a plurality of pairs of strip-like elements of said carcass ply 7 that enclose it as is a noose (see for instances FIGS. 1 through 3).

Preferably the strip-like elements, ranging in length between 3 mm and 15 mm, and having a thickness of 0.5 mm to 2.5 mm, contain a number of cords ranging between 2 and 15, with a density of 2 to 10 cords per centimetre, measured on the carcass ply, in circumferential direction, in proximity to the equatorial plane of the tyre 1.

The Applicant has found preferable the use of a metallic cord, selected among those usually adopted in the manufacture of tyre carcasses, with elementary wire having a diameter of 0.14 to 0.23 mm, in the known formation 7×4×0.175 WLL (wrapped cord) with the aforesaid densities.

Continuing with the manufacture of the aforesaid tyre 1, in a position axially external and radially internal to the aforesaid carcass ply 7 is preferably laid a second reinforcing annular core in a position that is axially external to said bead ring 5. Said second reinforcing annular core also comprises a bead ring 6, substantially shaped as an annulus concentric to the axis of rotation of the tyre, comprising at least an elongated metallic element wound according to multiple, substantially concentric coils, radially superposed and set axially side by side. The coils can be defined by a continuous spiral or by concentric rings formed by respective elongated metallic elements.

Optionally, the laying of other elongated elements of elastomeric material, used as fillers 10 for the bead area, can follow. Obviously, the laying of the carcass ply 7 can be followed by the laying of a second carcass ply in the same manner, and the laying of a single carcass ply 7 can be performed by differently offsetting the laying of each individual strip-like element, for instance leaving crown-wise between a strip-like element and the next a space, in the circumferential direction, equal to twice the transverse width of each strip-like element. It is thereby possible to lay, as illustrated above, a first elongated metallic element followed by the laying of a second series of strip-like elements, to lay a second elongated metallic element, then the third and last series of strip-like elements (having provided during the laying of the first series of strip-like elements the offset illustrated above), obtaining a bead that has a plurality of elongated metallic elements (two in this example) enclosed between strip-like elements of the same carcass ply.

The laying of the second elongated metallic element may also not take place, in which case the first elongated metallic element 13 will not be enclosed by pairs of strip-like elements, but by sets of three strip-like elements. Then, by appropriately varying the laying of the first series of strip-like elements and the number of elongated metallic elements one can obtain, as is readily apparent, the preferred configuration, employing the methodology described above.

Subsequently, the other elements constituting the tyre 1, i.e. the belt structure 8 and the tread band 9, will be laid.

Globally, therefore, proceeding from the crown area towards the bead, one observes in the finished tyre as shown in FIG. 2, an area with uniform density of each carcass ply 7 (i.e. the cords belonging to the strip-like elements constituting said ply were laid in such a way as to maintain a constant density of cords per cm in the same radial position), to a height “Z” usually lesser than 50 mm (measured in radial direction starting from the fitting line of the tyre 1, see FIG. 2) and preferably of about 15 mm. Subsequently, an area follows with height “Q” in radial direction, ranging between 1 and 35 mm, preferably about 12 mm, in which a portion of each carcass ply is present which encloses within itself said insert 15. Lastly, a portion of each carcass ply follows still with constant density to the radially inner end of the carcass ply/bead rings complex with height Z-Q in the radial direction, and equal for example to about 3 mm.

Note that the set of the areas in straight section of said bead rings 5, 6 defines a field 4 that contains said bead rings. Preferably, said field 4 substantially delimits the straight section area occupied by said bead rings.

In a different embodiment of the tyre 1 according to the invention, said insert 15 comprising in conjunction or alternatively elastomeric material and at least an elongated metallic element can be pre-manufactured separately and applied on the tyre in a single phase.

In a preferred embodiment of the tyre 1, the radially innermost ends of each carcass do not extend beyond the radially innermost profile of said bead rings 5, 6, or in any case do not wrap around said bead rings 5, 6.

Note that, in the tyre according to the invention, the neutral profile of the carcass ply/plies along its development between the beads has a continuous curvature without inflexion points, and the passage of said neutral profile inside said field 4, and preferably through the centre of gravity of the set of bead rings, prevents the set of said bead rings from being subjected to a torque, so that said set must withstand solely the tensile stresses applied to its straight section by effect of the forcing on the bead seat.

The Applicant has also observed that considering the insert—carcass ply/plies set as a single element, the carcass increases the interface surface with the parts of the bead rings that are external to the above defined set, thereby reducing the average load on the elastomeric material. Moreover, the carcass when subjected to traction by the internal inflation pressure required to support the applied load, tends to drive with it also what is interposed, because it is structurally more compliance than what is located externally.

To this movement corresponds for the continuity of the entire bead structure a radially external displacement of the spiralled cords of the bead ring that is axially internal relative to each carcass ply. These movements cause a deformation of the cords of the aforesaid bead ring: said deformation is followed by the reaction of the cords (provided with their own elastic module) which generates, at the mechanical level, a pincer effect that tends to immobilise the entire field 4, thereby opposing any possible disengagement of the carcass ply.

It should be noted, moreover, that the particular conformation of the field 4 obtained as illustrated above, makes the tyre 1 more reliable for equal loading conditions. The Applicant believes, without thereby constraining itself to any interpretative theory, that the particular conformation of said field 4 in which the carcass ply encloses between some of its strip-like elements an insert (formed for instance by a spiralled metallic element and by a filler made of elastomeric material) achieves, in addition to what has been illustrated above, also an effective block against the propagation of any cracks generated in the carcass-bead rings coupling area. In this case, there no longer is a preferential circumferential passage through the cracks may propagate.

In a different embodiment, between carcass ply and bead rings or within the same bead rings can be placed one or more reinforcing inserts 11 (see for instance FIG. 4) made of different materials as long as they are compatible with the elastomeric material used for the tyre 1, such as metal cords, fibre glass, nylon, etc. Said reinforcing inserts can also be constituted by strips of angled fabric and/or by strips of compounds reinforced with short fibres. The laying height “H” of said reinforcing inserts 11 measured in the radial direction preferably varies between 20 and 100 mm starting from the fitting line (as shown in FIG. 4).

Said reinforcing inserts 11 further contribute to optimise stress distribution between carcass and bead rings, graduating them in order further to impede the possible formation of cracks. Moreover, in this case as well the particular position of said reinforcing inserts 11 makes it difficult in any case for any crack that should be generated to propagate, due to the lack of a preferential propagation path.

In a further preferred embodiment, shown in FIG. 5, the tyre 1 has a reinforcing edge 12 on at least a bead, in a radially internal and axially external position of said bead, comprising lenghtened reinforcing elements positioned inclined relative to the radial direction, preferably built with metal cord having elementary filaments with diameter ranging between 0.15 and 0.30 mm. Alternatively, it is possible to use textile cords, for instance made of Kevlar, of other natural or synthetic fibres or of fibre glass. Said edges 12 can have two series of lenghtened elements, the elements of each series axially superposed and crossed with those of the adjacent series, or a plurality of said lenghtened elements positioned coplanar and substantially parallel to each other.

Said elements can be positioned directly on the carcass structure or previously buried in a strip of elastomeric material subsequently assembled to said carcass.

Preferably, the Applicant uses a strip of elastomeric material reinforced with metal cords of the type 3×7×0.20 HE, where the angle of laying is between 0° and 65°. Preferably, the strip is developed for a height “h1” of 10 mm to 70 mm, measured starting from the fitting line of said tyre 1.

1-12. (canceled)

13. A tyre for a vehicle wheel, comprising:
a toroidal carcass;
a tread band; and
a belt structure;
wherein the carcass comprises:
a central crown portion; and
two axially opposite sidewalls;
wherein the axially opposite sidewalls end in a pair of beads for mounting the tyre on a corresponding rim,
wherein each bead comprises at least one annular reinforcing core,
wherein the tread band is disposed at the central crown portion of the carcass,
wherein the tread band coaxially extends about the carcass,
wherein the tread band comprises a relief pattern for rolling contact with the ground,
wherein the belt structure is coaxially interposed between the carcass and the tread band,
wherein the carcass further comprises at least one carcass ply,
wherein ends of the at least one carcass ply are anchored to the annular reinforcing cores, and
wherein the at least one carcass ply comprises a portion that encloses at least one insert in proximity to the annular reinforcing cores.

14. The tyre of claim 13, wherein the at least one insert comprises at least one elongated metallic element comprising a plurality of radially superposed coils.

15. The tyre of claim 14, wherein the at least one elongated metallic element is associated with a filler of elastomeric material.

16. The tyre of claim 14, wherein the at least one elongated metallic element comprises a plurality of wires, and
wherein each wire has an ultimate tensile stress greater than or equal to 500 N and less than or equal to 5000 N.

17. The tyre of claim 13, wherein the at least one insert comprises an elastomeric material.

18. The tyre of claim 17, wherein the elastomeric material has a Shore A hardness greater than or equal to 70 degrees and less than or equal to 90 degrees.

19. The tyre of claim 18, wherein the at least one carcass ply comprises a plurality of strip elements that enclose the at least one insert.

20. The tyre of claim 19, wherein each strip element is laid onto a toroidal support with a circumferential pitch equal to twice a width of the strip elements,
wherein an outer profile of the toroidal support substantially coincides with a radially inner surface of the tyre, and
wherein each strip element, together with an adjacent strip element, encloses at least part of the at least one insert.

21. The tyre of claim 13, wherein the carcass has a neutral profile, lying in a radial straight section plane, axially extended from bead to bead,
wherein the neutral profile intersects a straight section of fields that encloses respective annular reinforcing cores, and
wherein the neutral profile has a continuous curvature without inflection points along its development between the beads.

22. The tyre of claim 13, wherein the at least one insert has a height measured in a radial direction greater than or equal to 1 mm and less than or equal to 35 mm.

23. The tyre of claim 13, wherein the tyre comprises at least one reinforcing insert in a radially external position to the annular reinforcing cores.

24. The tyre of claim 13, wherein the tyre comprises a reinforcing edge,
wherein the reinforcing edge is disposed axially external to at least one of the beads, and
wherein the reinforcing edge is disposed radially internal to the at least one of the beads.
